(19) United States
(12) Patent Application Publication
(10) Pub. No.: US 2010/0097970 A1
(43) Pub. Date: Apr. 22, 2010

(54) METHOD AND DEVICE FOR DISPLAYING INFORMATION OF MOBILE TERMINAL

(75) Inventor: Sun Hee Jang, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/582,089

(22) Filed: Oct. 20, 2009

(30) Foreign Application Priority Data
Oct. 21, 2008 (KR) 10-2008-0103031

(51) Int. Cl. G08C 17/00; H04M 1/00

(52) U.S. Cl. 370/311; 455/566

(57) ABSTRACT

A method and device for displaying information of a mobile terminal has an information display. The terminal includes: a display unit for outputting at least one of a standby screen, a screen corresponding to activation of a program, a data-free screen corresponding to a sleep mode, and a screen for displaying preset information. A controller directing display of the preset information for a predetermined information display time period beginning from at least one of a time point prior to entering the sleep mode and a time point of exiting from the sleep mode. An input unit permits input of a signal for exiting from the sleep mode; and a storage unit for storing the preset information.

### CLAIM OF PRIORITY

This application claims priority from an application entitled “METHOD AND DEVICE FOR DISPLAYING INFORMATION OF MOBILE TERMINAL” filed in the Korean Intellectual Property Office on Oct. 21, 2008 and assigned Serial No. 10-2008-0103031, the contents of which are incorporated herein by reference in its entirety.

### BACKGROUND OF THE INVENTION

1. Field of the Invention

The present invention relates to a method and device for displaying information of a mobile terminal. More particularly, the present invention relates to a method and device for displaying information of a mobile terminal that can display preset information.

2. Description of the Related Art

Nowadays, mobile terminals are very widely used, particularly due to the advantage that communication can be performed while mobile. Such a mobile terminal has a small size due to recent developments in technology and has a battery capacity that can sustain a long standby time period due to development of various materials, so that one can typically use the phone on a daily basis with only a small recharge time once a day so as not to exhaust the batteries.

A mobile terminal provides new services by integrating a number of formerly discrete devices, such as a camera and an MP3 player, as well as providing a communication service while mobile. Particularly, due to development of a memory and a central processor necessary for operating the memory, the mobile terminal has a storage space that can store various data and can quickly process data.

A user uses the mobile terminal for various applications such as schedule management, news viewing, and memo writing. Such various applications include convenient functions for providing information to the user. However in order for the user to determine certain preset information, various hierarchical menus for performing a corresponding information viewing function are activated.

### SUMMARY OF THE INVENTION

The present invention provides a method and device for displaying information of a mobile terminal that can effectively perform an information viewing operation by controlling the display of information set by a user at an appropriate time point at which the user wishes to use the mobile terminal.

In accordance with an exemplary aspect of the present invention, a method of displaying information of a mobile terminal includes: outputting one of a standby screen and a screen corresponding to activation of a program; entering, if an input signal is not received during a first time period, a sleep mode; receiving an input signal for exiting from the sleep mode; supplying power to a display unit upon exiting from the sleep mode; displaying preset information in the display unit for a second time period; and outputting, after the second time period has elapsed, one of the standby screen and a screen corresponding to activation of a program.

In accordance with another exemplary aspect of the present invention, a method of displaying information of a mobile terminal includes: outputting one of a standby screen and a screen corresponding to activation of a program; determining whether to enter a sleep mode, if an input signal is not received during a first time period; displaying, before entering the sleep mode, preset information in a display unit for a second time period; and interrupting, after the second time period has elapsed, power supplied to the display unit upon entering the sleep mode.

In accordance with another exemplary aspect of the present invention, an information display device of a mobile terminal includes: a display unit for outputting one of a standby screen, a screen corresponding to activation of a program, a data-free screen corresponding to a sleep mode, and a screen for displaying preset information; a controller for controlling a display of the preset information for a predetermined information display time period beginning from at least one of a time point prior to entering the sleep mode and a time point of exiting from the sleep mode; an input unit for inputting a signal for exiting from the sleep mode; and a storage unit for storing the preset information.

### BRIEF DESCRIPTION OF THE DRAWINGS

The exemplary objects, features and advantages of the present invention will become more apparent to a person of ordinary skill in the art from the following detailed description in conjunction with the accompanying drawings, in which:

FIG. 1 is a block diagram illustrating a configuration of a mobile terminal according to an exemplary embodiment of the present invention;

FIG. 2 is a block diagram illustrating a configuration of a controller in the mobile terminal of FIG. 1;

FIG. 3 illustrates an example of a screen interface of a display unit in the mobile terminal of FIG. 1;

FIG. 4 is a flowchart illustrating an exemplary operation of setting information display in a method of displaying information of a mobile terminal according to another exemplary embodiment of the present invention;

FIG. 5 is a flowchart illustrating an exemplary operation of displaying information when exiting a sleep mode in the method of FIG. 4; and

FIG. 6 is a flowchart illustrating an exemplary operation of displaying information prior to entering a sleep mode in the method of FIG. 4.

### DETAILED DESCRIPTION

Hereinafter, exemplary embodiments of the present invention are described in detail with reference to the accompanying drawings. The same reference numbers are used throughout the drawings to refer to the same or similar parts. The views in the drawings are schematic views only, and are not intended to be to scale or correctly proportioned. Detailed descriptions of well-known functions and structures incorporated herein may be omitted to avoid obscuring appreciation of the subject matter of the present invention to a person of ordinary skill in the art with such description of well-known functions and structures.

While the present invention may be embodied in many different forms, specific embodiments of the present invention are shown in drawings and are described herein in detail for illustrative purposes, with the understanding that the present disclosure is to be considered as an exemplification of the principles of the invention and is not intended to limit the claimed invention to the specific embodiments illustrated.

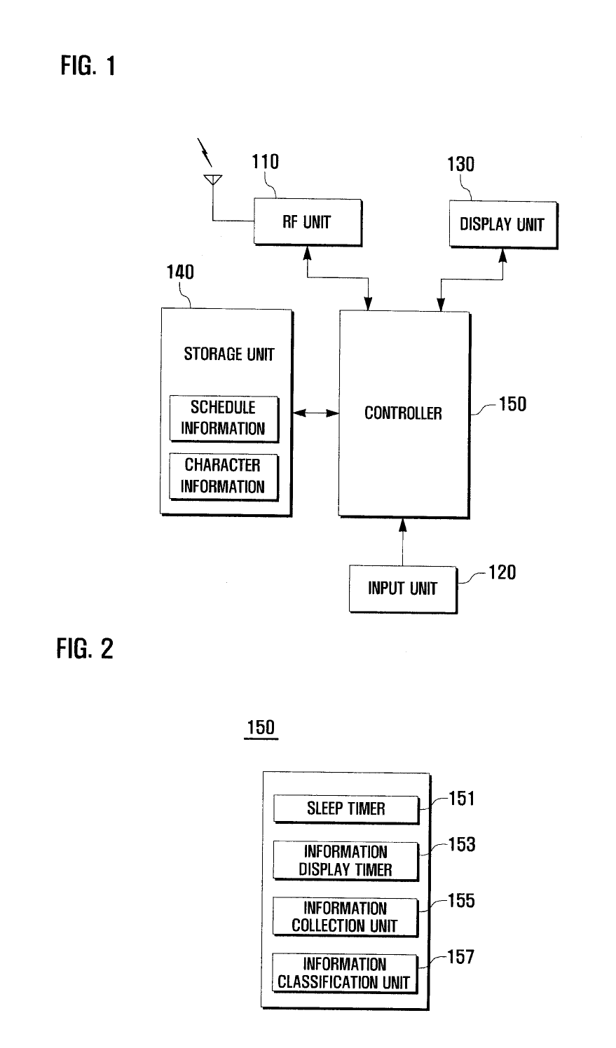

FIG. 1 is a block diagram illustrating an exemplary configuration of a mobile terminal according to an exemplary embodiment of the present invention.

Referring now to the example shown in FIG. 1, the mobile terminal according to the present exemplary embodiment preferably includes a radio frequency (RF) unit 110, input unit 120, display unit 130, storage unit 140, and controller 150.

The mobile terminal controls the display of schedule information set by a user and stored in the storage unit 140, and character information received from a specific server or another mobile terminal through the RF unit 110 for a preset time period prior to entering, and upon exiting from, a sleep mode of the mobile terminal.

The RF unit 110 transmits and receives a sound signal and an audiovisual signal when performing communication by the control of the controller 150. The RF unit 110 includes an RF transmitter for up-converting a frequency of a signal to be transmitted and amplifying the signal, and an RF receiver for low-noise amplifying a received signal and down-converting a frequency of the signal. More particularly, in the present exemplary embodiment, the RF unit 110 is connected to a specific server (not shown) by the control of the controller 150 and receives character information, for example financial information, weather information, news information, entertainment information and sports information, provided from a corresponding server in a character form according to a preset condition.

The input unit 120 includes a plurality of input keys and function keys for inputting numerical and character information and setting various functions. The function keys include but are in no way limited to a direction key, side key, and a hotkey set to perform a specific function. Further, the input unit 120 is used by a user for inputting a key signal related to user setting and function control, and outputs the key signal to the controller 150. Particularly, the input unit 120 is used for inputting an input signal for setting a preset information display for displaying prior to entering a sleep mode, and an input signal for setting a preset information display for displaying when exiting a sleep mode, for inputting an input signal for selecting at least one preset information, for example, schedule information and character information, and for inputting an input signal for exiting from a sleep mode while in the sleep mode through a user's manipulation, and for outputting the input signal to the controller 150.

The display unit 130 provides a screen, for example, a standby screen, menu screen, file reproduction screen, and communication screen according to various functions of the mobile terminal. The display unit 130 can use a liquid crystal display (LCD), in which case the display unit 130 includes an LCD controller, memory for storing data, backlight unit, and LCD display element. However, any thin-screen technology compatible with a mobile terminal can be used. If the LCD provides a touch screen operation method, a screen of the display unit 130 can be operated as an input unit. More particularly, in the present exemplary embodiment, the display unit 130 displays schedule information and character information stored in the storage unit 140 in a preset form at a time point set by the user, namely at a time point prior to the time point at which the mobile terminal enters a sleep mode or a time point at which the mobile terminal exits from the sleep mode. A screen interface of the display unit 130 is described later in detail with reference to the drawings.

Still referring to FIG. 1, the storage unit 140 stores an application program necessary for operating units of the mobile terminal, for example the RF unit 110 and the display unit 130, according to the present exemplary and an application program necessary for operating the mobile terminal. The storage unit 140 stores various data generated when using the application program. When performing a communication function and when receiving character information from a specific server, the storage unit 140 preferably performs a function of buffering data and image information according to a designated capacity. The storage unit 140 preferably includes a program area and a data area.

The program area stores an operating system for booting the mobile terminal, a sleep mode program module, an information display program module, a schedule management program module, and a character information collection program module. Further, the program area preferably stores an application program necessary for other option functions of the mobile terminal, for example a sound reproduction function and an image or moving picture reproduction function.

The sleep mode program module preferably executes an operation program for reducing power consumption by reducing power supplied to the display unit 130 when no separate input signal is received in the mobile terminal during a preset time period. The sleep mode program module preferably adjusts a setting of the time period for entering a sleep mode according to user setting. When entering a sleep mode, the sleep mode program module reduces the power supplied to at least one of a backlight unit and an LCD display element constituting the display unit 130. Accordingly, a dimming phenomenon occurs in the display unit 130 in the sleep mode. When an input signal is input through the input unit 120, the controller 150 exits from the sleep mode. That is, when an input signal is input in a sleep mode state, the sleep mode program module returns a screen of the display unit 130 to its original brightness by controlling to supply power to the display unit 130.

The information display program module is activated according to a user setting when the sleep mode program module is activated. That is, prior to the mobile terminal entering a sleep mode or when exiting from the sleep mode according to activation of the sleep mode program module, the information display program module controls to display specific information stored in the storage unit 140 for a preset time period in the display unit 130. In this case, a preset time period for displaying information and the kind of information are selected by the user. A display form of information can be changed according to a form designed by a designer or user setting.

The schedule management program module activates a pop-up window or a menu screen for managing a schedule according to a user's input, stores information input by the user related to a schedule, and manages a schedule by activating an alarm at a specific date or time. The schedule management program module can input a user's schedule information, event information, and to-do information, and each information is input together with a date or a predetermined time interval in order to activate an alarm at the specific date or at the predetermined time interval. The input information is stored in the data area of the control unit 140 as schedule information according to activation of the schedule management program module.

The character information collection program module is preferably a program for collecting character information, for example financial information, weather information, news information, entertainment information and sports information, from a specific server designated by the user. When the user inputs address information corresponding to a specific server to an input window, the character information collection program module connects to the server having the address information input by the user at a preset time interval and receives the character information in a text form. If a specific server provides character information with a push-type method, the character information collection program module extracts character information from the data received by the RF unit 110 at a predetermined time interval and stores the character information in the data area of the storage unit 140.

The mobile terminal activates each program module by control of the controller 150 according to a user's request, collects information according to the function of the corresponding module, and provides the information to the user.

The data area of the storage unit 140 is an area for storing data generated when using the mobile terminal and stores data transmitted and received through the RF unit 110 and data input by the user. Particularly, in the present exemplary embodiment, the data area stores schedule information and character information input or received according to activation of one of the program modules. The schedule information and the character information are displayed in the display unit 130 prior to entering a sleep mode or when exiting from the sleep mode by action of the information display program module.

The controller 150 turns on the mobile terminal when power is supplied, supplies power necessary for activating each unit according to user setting, and initializes each unit. The controller 150 directs output of a menu screen for preset information display according to a signal input from the input unit 120 and controls, when the user selects setting of information display, output a menu screen for selecting at least one of a time point prior to entering a sleep mode and a time point for exiting the sleep mode, at which time points of the preset information is displayed. When the user selects to set information to be displayed prior to entering a sleep mode and when exiting from the sleep mode, the controller 150 controls to output a menu screen for selecting information to display. Here, the user can select at least one of a plurality of information, i.e. schedule information and character information, and the controller 150 sets the kind of information to be displayed according to the user's selection. Thereafter, the controller 150 determines whether the mobile terminal is about to enter a sleep mode or is exiting from a sleep mode and controls to display corresponding preset information for a preset time period. For this, the controller 150 includes a sleep timer 151, information display timer 153, information collection unit 155, and information classification unit 157, as shown in FIG. 2.

Referring now to FIG. 2 for some detail of the controller 150, the sleep timer 151 is a timer for determining the elapse of a predetermined first time period corresponding to a time period prior to a time point at which the mobile terminal enters a sleep mode. If the first time period is set to, for example, 20 seconds, the sleep timer 151 is activated after a previous input signal is input to the mobile terminal to determine when the first time period elapses. If an input signal is not input during the first time period, which is not within the 20 seconds, the controller 150 controls the mobile terminal to enter the sleep mode.

The information display timer 153 is a timer for determining the elapse of a predetermined second time period during which information is displayed. The information display timer 153 enables the user to set the second time period during which the information display program module is activated. For this, the controller 150 controls to display an input window for setting the second time period while controlling to output a menu screen related to activation of the information display program module. The information display timer 153 is activated for the predetermined second time period prior to entering a sleep mode, and is activated for the predetermined second time period after exiting from the sleep mode. Specifically, if the first time period prior to entering a sleep mode is set to 30 seconds, and the predetermined second time period for display of preset information is set to 10 seconds, when 20 seconds has elapsed after activation of the sleep timer 151, the controller 150 activates the information display timer 153 and controls to display preset information. When the information display timer 153 determines that the second time period has elapsed, the controller 150 removes the display of the preset information and controls the mobile terminal to enter a sleep mode according to termination of the sleep timer 151. Alternatively, the information display timer 153 is set to operate after the sleep timer 151 is terminated. For example, when the first time period is set to 30 seconds after a previous input signal is input, if no input signal is input during the 30 second first time period, the controller 150 does not enter a sleep mode, but instead activates the information display timer 153 and controls to display preset information in the display unit 130. When the information display timer 153 determines that the second time period is elapsed, the controller 150 controls the display unit 130 to delete the displayed information and to enter a sleep mode. Further, when the controller 150 is set to display preset information when exiting from the sleep mode, if a specific input signal is input to the mobile terminal in a sleep mode, the mobile terminal exits from the sleep mode and the controller 150 activates the information display timer 153 and controls to display preset information in the display unit 130 until the information display timer 153 determines that the second time period is elapsed. After the information display timer 153 is terminated, the controller 150 controls to activate a screen, for example a standby screen or an activated screen, before the mobile terminal again enters a sleep mode according to the previously described process.

Still referring to FIG. 2, the information collection unit 155 collects schedule information and character information stored in a program area of the storage unit 140 and directs display of the schedule information and character information in the display unit 130. That is, the information collection unit 155 controls to read information to be displayed before entering a sleep mode or after exiting from the sleep mode in the storage unit 140 according to a user's setting, and to display the corresponding information in a preset format. For example, when the information collection unit 155 is directs display of schedule information previously selected by the user, the information collection unit 155 reads the stored schedule information in the storage unit 140 and displays the schedule information when entering a sleep mode and when exiting from a sleep mode.

The information classification unit 157 classifies information collected according to activation of the schedule management program module and the character information collection program module in a form that can be displayed in the display unit 130. The information classification unit 157 directs division of schedule-related information input by the user into information types, for example time schedule information, event information, and to-do information according to activation of the schedule management program module and to classify the information, and to store the information as schedule information. The information classification unit 157 determines the type of character information received from a specific server or another mobile terminal corresponding to activation of the character information collection program module and classifies the information according to each information characteristic. For example, if character information received from a server is information related to entertainment, sports, news, and entertainment, the information classification unit 157 classifies the kind of each information in consideration of a category of the received information or the occurrence frequency of words included in each information. For example, when classifying information according to the occurrence and/or frequency of words, for example, if a word such as a “baseball” and a “soccer” is included in the corresponding character information, the information classification unit 157 may classify the information as sports information, and if words such as “stock” and an “exchange rate” are included in the corresponding character information, the information classification unit 157 may classify the information as economic information.

As described above, the display unit 130 displays preset information before entering or when exiting from a sleep mode, and thus the user can view specific information at an appropriate time point.

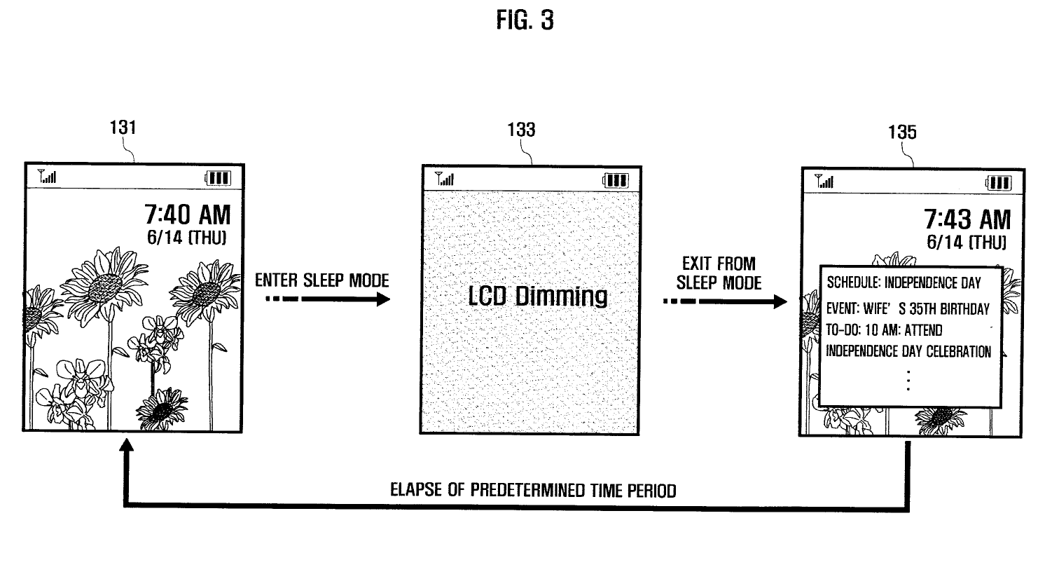

FIG. 3 illustrates an example of a screen interface of a display unit in the mobile terminal of FIG. 1.

Referring now to FIG. 3, when power is supplied to the mobile terminal, the mobile terminal is turned on and the controller 150 directs an output of a preset standby screen 131.

Thereafter, the controller 150 activates the sleep timer 151 and controls, if an input signal is not input within a preset time period, the mobile terminal to enter into a sleep mode. When the mobile terminal enters the sleep mode, the controller 150 prevents power being supplied to at least one of a backlight unit and an LCD panel of the display unit 130. Accordingly, the display unit 130 dims and then displays a blank screen 133.

If an input signal is input to the mobile terminal in a sleep mode, the sleep mode is released. When the sleep mode is released, the controller 150 activates the information display timer 153 and controls the display unit 130 to display a preset information display screen 135. The information display screen 135 is an example of a screen for displaying schedule information of the user. Accordingly, the screen 135 displays schedule information such as “Independence Day”, event information such as “wife's 35th birthday”, and to-do information such as “10 AM: Attend Independence Day celebration.”

When the information display timer 153 is terminated while the information display timer 153 is being displayed after exiting from the sleep mode, the controller 150 controls to output the standby screen 131, so when another program is activated before entering a sleep mode, the corresponding program is output on an activated screen.

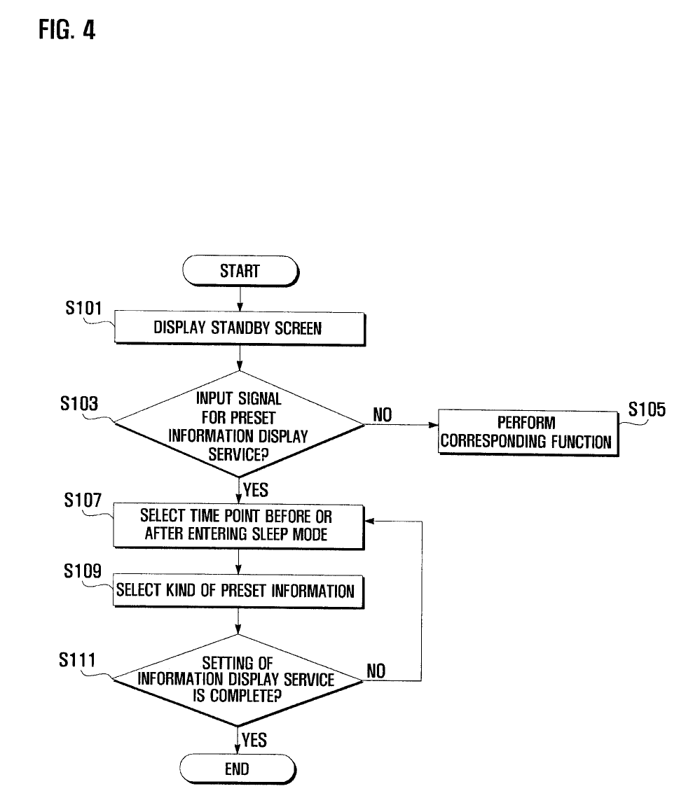

FIG. 4 is a flowchart illustrating an exemplary operation of a preset information display in a method of displaying information of a mobile terminal according to another exemplary embodiment of the present invention.

Referring now to FIG. 4, when power is supplied, the controller 150 turns on the mobile terminal and directs the display of a preset standby screen in the display unit 130 (101).

When an input signal is input through the input unit 120, the controller 150 determines whether the input signal is an input signal for setting an information display service (103). If the input signal is not an input signal for setting an information display service, the controller 150 controls to perform a function corresponding to the input signal, for example a communication function, message writing function, and file reproduction function (105).

If the input signal is an input signal for setting an information display service, the controller 150 controls to output a menu screen for selecting a time point at which information is to be displayed before or after entering a sleep mode and controls to set an information display time point according to an item selected by the user (107).

The controller 150 selects the kind of preset information (109). For this, the controller 150 directs output of a menu screen for selecting the kind of preset information, for example, one of schedule information and character information. Accordingly, the user can select a desired item from a corresponding menu screen using the input unit 120, and the selected input signal is output to the controller 150 for the controller 150 to determine the kind of preset information.

The controller 150 determines whether setting of the information display service is complete (111). If setting of the information display service is not complete, the process returns to step 107.

The controller 150 directs output of a menu screen for setting an information display time period, in order for the information display timer 153 to determine a termination time point of the information display. Accordingly, when a screen for setting a time period of the information display timer 153 is output, the user can directly input the information display time period using the input unit 120.

When setting of the information display service is complete, the controller 150 determines a preset time period for activation of the information display timer 153.

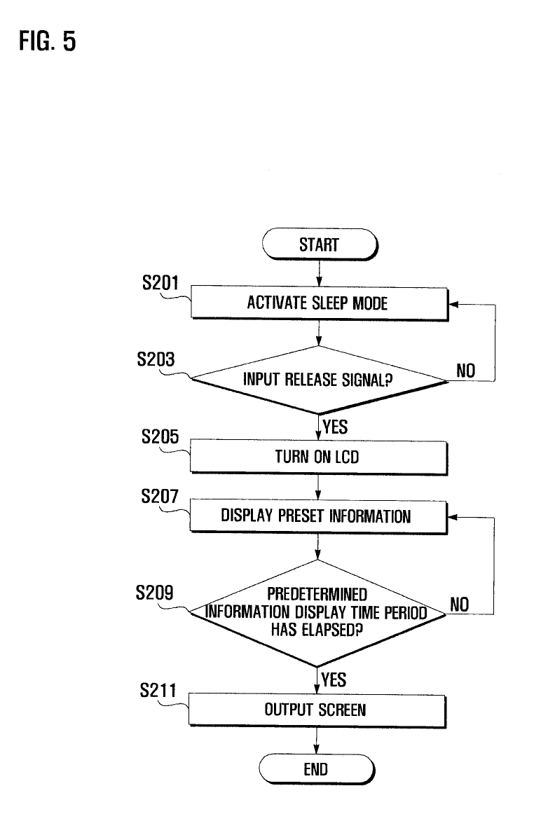

FIG. 5 is a flowchart illustrating an operation of displaying information when exiting from a sleep mode in the exemplary method of FIG. 4.

Referring now to FIG. 5, when the mobile terminal is activated, if an input signal is not input while the sleep timer 151 is activated, the controller 150 activates a sleep mode of the mobile terminal (201). Accordingly, power supplied to an LCD panel of the display unit 130 is reduced/prevented and thus a lamp is dimmed, or a blank screen is displayed.

The controller 150 determines whether a release signal is input through the input unit 120 (203). If the input unit 120 is a touch panel, the controller 150 determines whether a touch event has occurred.

If a release signal is not input through the input unit 120, the process returns to step 201 and the controller 150 directs that sleep mode be sustained.

If a release signal is input through the input unit 120 at step 203, the controller 150 determines the signal to be a sleep mode release signal and directs power to be supplied to an LCD panel or the backlight unit of the display unit 130 (205). Here, the sleep mode release signal is described as a release signal, however the sleep mode release signal can be designated to a specified hotkey and can be set to any input signal input by a keypad or a touch pad.

When power is supplied to the display unit 130 at step 205, the controller 150 directs a display of preset information (207). Here, the preset information may be specific information, for example schedule information or character information set by the user in the method of setting the information display, or when the preset information is not set by the user, the preset information may be information set to a default value by the controller 150. The controller 150 directs activation of the information display timer 153 at a display time point of information at step 207.

The controller 150 determines whether a predetermined information display time period has elapsed (209). That is, the controller 150 determines whether or not the activated information display timer 153 has terminated. If the activated information display timer 153 has not terminated, the process then returns to step 207 and the controller 150 directs a continues display of the preset information.

If a predetermined information display time period has elapsed, that is, if the activated information display timer 153 has terminated, the controller 150 directs the display unit 130 to display a screen of the mobile terminal, for example a standby screen or a screen corresponding to a specific activated program (211).

As described above, in the information display method according to the present exemplary embodiment, when the user has not used the mobile terminal for a predetermined time period and then begins to use it again, by enabling to display preset information necessary for the user immediately after being exiting from a sleep mode, information alarm and information transmission can be effectively improved.

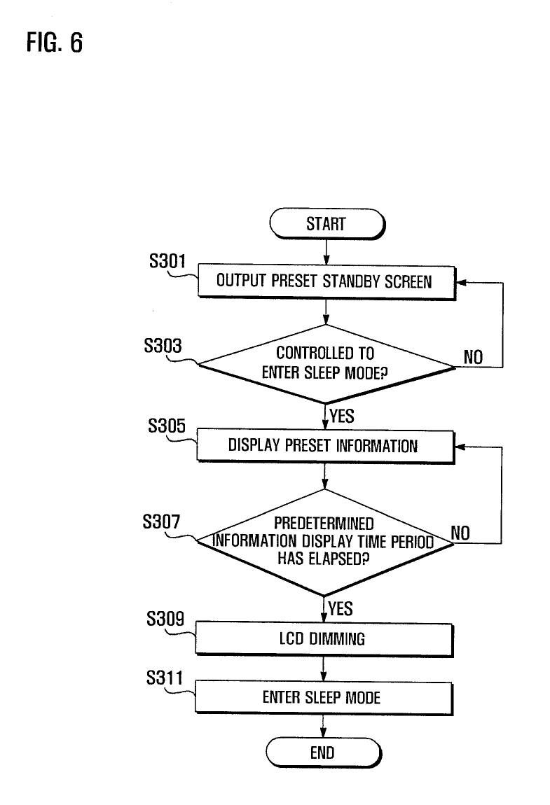

FIG. 6 is a flowchart illustrating an operational example of a method of displaying information prior to entering a sleep mode in the method of FIG. 4.

Referring now to FIG. 6, when power is supplied to the device, the mobile terminal is turned on and the controller 150 directs output of a preset standby screen to the display unit 130 (301).

The controller 150 determines whether or not the mobile terminal is directed to enter a sleep mode (303). Specifically, the controller 150 determines whether an input signal is input through the input unit 120 before a predetermined time period has elapsed in a state where a standby screen is output. If no input signal is input through the input unit 120 during the predetermined time period, the controller 150 determines that the mobile terminal is entering into a sleep mode. For this function, the controller 150 activates the sleep timer 151 when a previous input signal is input through the input unit 120, and determines whether or not the sleep timer 151 terminates without a further input signal being input.

If the mobile terminal is not controlled to enter a sleep mode at step 303, i.e. if an input signal is input before the sleep timer 151 terminates, the process then returns to step 301 and the controller 150 continues to output a standby screen or to perform a function of the mobile terminal.

If the mobile terminal is controlled to enter a sleep mode at step 303, i.e. if the sleep timer 151 terminates, the controller 150 controls to display preset information in the display unit 130 (305). Here, the preset information may comprise schedule information or character information set by the user in an information display setting process, as described above, or when the preset information is not set by the user, the preset information may be information set to a default value by the controller 150. The controller 150 activates the information display timer 153 at a start time point of displaying the preset information.

The controller 150 determines whether a predetermined information display time period has elapsed, i.e. whether the information display timer 153 has terminated (307).

If a predetermined information display time period has not elapsed, i.e. if the information display timer 153 has not terminated, the process returns to step 305 and the controller 150 continues to display the presently displayed preset information.

If a predetermined information display time period has elapsed, i.e. if the information display timer 153 has terminated, in order to enter a sleep mode of the mobile terminal, the controller 150 prevents power from being supplied to an LCD panel or a backlight unit of the display unit 130 to control the display unit 130 to display a blank screen (309).

The controller 150 directs the mobile terminal to enter the sleep mode (311).

As described above, in a method of displaying information according to the present invention, by providing necessary information to the user before the mobile terminal enters a sleep mode, information transmission can be effectively performed and appropriate information can be provided at a time when the mobile terminal is not used.

In the method of displaying information of the present exemplary embodiment, the controller 150 obtains schedule information and character information corresponding to preset information input by a user and to data received by the RF unit 110. That is, the controller 150 activates a schedule management program module according to a user's request, collects schedule information input by the user, controls to receive text information provided by a corresponding server according to a user's setting or specific service registration, classifies and stores the information, and outputs the information as character information.

As described above, in a method and device for displaying information of a mobile terminal according to the present invention, by enabling to appropriately display various information set by a user while using the mobile terminal, information viewing can be effectively performed.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

What is claimed is:

1. A method of displaying information of a mobile terminal, comprising:
entering a sleep mode, if an input signal is not received by a controller during a first time period;
receiving an input signal for exiting from the sleep mode;
supplying power to the display unit upon exiting from the sleep mode;
displaying preset information in the display unit during a second time period; and
outputting by the controller one of a standby screen and a screen corresponding to activation of a program when it is determined that the second time period has elapsed.

2. The method of claim 1, wherein prior to entering a sleep mode includes outputting by the controller one of a standby screen and a screen corresponding to activation of a program to a display unit.

3. The method of claim 1, wherein entering a sleep mode comprises:
activating a sleep timer for determining a termination time of the first time period; and
determining whether the sleep timer has terminated.

4. The method of claim 1, wherein displaying preset information in the display unit for a second time period comprises:
activating, upon exiting from the sleep mode, an information display timer for determining a termination time of the second time period; and
displaying the preset information until the information display timer terminates.

5. The method of claim 4, further comprising:
outputting a menu screen for setting the information display timer; and
setting the second time period of the information display timer according to a signal input through an input unit.

6. The method of claim 1, further comprising collecting the preset information for display,
wherein the preset information comprises at least one of:
schedule information input through an input unit according to activation of a schedule management program; and
text information received from at least one of a specific server and another mobile terminal and classified according to activation of a character information collection program, and stored as character information.

7. A method of displaying information of a mobile terminal, comprising:
entering a sleep mode if an input signal is not input during a first time period;
displaying preset information in a display unit for a second time period, before entering the sleep mode; and
interrupting power supplied to the display unit upon entering the sleep mode, after the second time period has elapsed.

8. The method of claim 7, wherein prior to entering sleep mode includes outputting by a controller one of a standby screen and a screen corresponding to activation of a program.

9. The method of claim 7, wherein determining whether to enter a sleep mode comprises:
activating by a controller a sleep timer for determining a termination time of the first time period; and
determining whether the sleep timer has terminated.

10. The method of claim 9, wherein displaying preset information in a display unit for a second time period comprises:
activating an information display timer for determining a second time period, upon termination of the sleep timer; and
displaying the preset information until the information display timer terminates.

11. The method of claim 9, wherein displaying preset information in a display unit for a second time period comprises:
activating, before the sleep timer has terminated, an information display timer for determining the second time period such that the information display timer terminates at the same time point as the sleep timer; and
displaying the preset information until the information display timer terminates.

12. The method of claim 10, further comprising:
outputting a menu screen for setting the information display timer; and
setting the second time period of the information display timer according to a signal input through an input unit.

13. The method of claim 11, further comprising:
outputting a menu screen for setting the information display timer; and
setting the second time period of the information display timer according to a signal input through an input unit.

14. The method of claim 7, further comprises collecting the preset information, wherein the preset information comprises at least one of:
schedule information received from an input unit corresponding to activation of a schedule management program; and
text information received from at least one of a specific server and another mobile terminal and classified according to activation of a character information collection program, and stored as character information.

15. An information display device of a mobile terminal comprising:
a display unit for outputting one at least one of a standby screen, a screen corresponding to activation of a program, a data-free screen corresponding to a sleep mode, and a screen for displaying preset information;
a controller for controlling display of preset information for a predetermined information display time period comprising from at least one of a time point prior to entering the sleep mode and a time point of exiting from the sleep mode;
an input unit for inputting a signal for exiting from the sleep mode; and
a storage unit for storing the preset information.

16. The information display device of claim 15, wherein the controller comprises:
a sleep timer for determining an expiration of the predetermined input-free time period, if no signal is received through the input unit during a predetermined time period; and
an information display timer for controlling display of the preset information for the predetermined information display time period.

17. The information display device of claim 16, wherein the information display timer is activated to terminate at the same time point as the sleep timer.

18. The information display device of claim 16, wherein the information display timer is activated upon termination of the sleep timer or activated upon exiting from the sleep mode.

19. The information display device of claim 16, wherein the controller controls the display unit to display a menu screen for inputting an input signal for setting the predetermined time period of the information display timer.

20. The information display device of claim 15, wherein the storage unit comprises:
a schedule management program module for collecting schedule information set according to an input signal input through the input unit; and
a character information collection program module for receiving and classifying text information received from at least one of a specific server and another mobile terminal, and for storing the text information as character information.
